(19) United States
(12) Patent Application Publication
(10) Pub. No.: US 2007/0077189 A1
(43) Pub. Date: Apr. 5, 2007

(54) CATALYST FOR IMPROVING THE EFFICACY OF NOx REDUCTION IN MOTOR VEHICLES

(75) Inventors: Stefan HUBIG, Urexweiler (DE); Kisnaduth KESORE, Marl (DE); Ronny MONNIG, Wiesbaden (DE); Helmut OSWALD, Albig (DE); Peter ZIMA, Mainz (DE)

Correspondence Address: INGRASSIA FISHER & LORENZ, P.C., 7150 E. CAMELBACK, STE. 325, SCOTTSDALE, AZ, 85251, US

(73) Assignees: GM Global Technology, Inc., Detroit, MI (US); S&B Industrial Minerals GMBH, Marl (DE); Fiat Auto S.p.A., Torino (IT)

(21) Appl. No.: 11/532,181

(22) Filed: Sep. 15, 2006

Related U.S. Application Data
(63) Continuation of application No. PCT/EP05/02656, filed on Mar. 12, 2005.

(30) Foreign Application Priority Data
Mar. 17, 2004 (DE) 10 2004 013164.3

(51) Int. Cl. B01J 29/08; B01J 29/18; B01J 29/00; B01J 21/16; B01J 29/06

(52) U.S. Cl. 423/239.2; 502/63; 502/64; 502/66; 502/68; 502/77; 502/78; 502/79; 502/80; 502/84

(57) ABSTRACT

The invention relates to a catalyst for purifying NOX in the flow of exhaust gas of motor vehicles, and is characterized in that the catalyst contains modified clay minerals selected from the group consisting of bentonites, smectites, hectorites and mixtures thereof, all of which being pillared with aluminium, silicon or titanium (oxides).

### CROSS-REFERENCE TO RELATED APPLICATIONS

This is a continuation of International Application No. PCT/EP2005/002656, filed Mar. 12, 2005, which application claims priority to German Application No. 10 2004 013164.3, filed Mar. 17, 2004, which are hereby incorporated by reference in their entirety.

### FIELD OF THE INVENTION

The invention relates to a catalyst for improving the efficacy of NOₓ reduction in motor vehicles.

### BACKGROUND OF THE INVENTION

Legislation has already provided for a drastic reduction in the limit values for pollutants in the Guideline EU IV for the future.

The so-called selective catalytic reduction process (SCR process) is known for reduction of the NOₓ content in the exhaust gas of an internal combustion engine operated with excess air. In this process, at a location upstream of a catalyst a selectively acting reducing agent is fed to the exhaust gas, mostly through injection, and through this reducing agent the NOₓ contained in the exhaust gas can be converted in a chemical reaction to eco-neutral components (N₂, O₂, H₂O) in the SCR catalyst. The known process is already applied today in diesel engines in the heavy-duty (truck) field, wherein frequently aqueous urea solutions (32.5% by mass; known under the name ‘AdBlue’) or solid urea in pelleted or powdered form are used. Reducing agents that exhibit a particularly active effect are those, from which ammonia can be released as an intermediary, e.g. urea, a urea-water solution, solid ammonium carbamate or gaseous ammonia. The said reducing agents can reduce nitrogen oxides by means of (vanadium oxide-containing) catalysts to more than 95% even with a non-stoichiometric dosage. With ammonia (NH₃) as reducing agent, this process has been successfully used for decades in power stations for the reduction of nitrogen oxide.

Solid or liquid materials are better suited for mobile use, these being harmless and eco-neutral, in contrast to toxic ammonia, while allowing the ammonia necessary for the catalytic reaction to be generated onboard a motor vehicle. An example of such a substance is urea, from which ammonia can be extracted through thermal decomposition, or preferably through hydrolytic processes. There is the problem that irrespective of the catalyst and reducing agent, the exhaust temperatures, e.g. in the cold start phase of the engine or during urban travel with frequent idling phases, are possibly not sufficient for the selective catalytic reduction. In particular, the precisely targeted addition (dosage) of the reducing agent then constitutes a complicated problem with respect to control that cannot always be resolved satisfactorily. There is the risk of a leakage of ammonia (breakthrough of free NH₃ through the catalyst), which must be absolutely avoided because of the toxicity of ammonia.

For this reason, the direct use, also without processing, of fuel as reducing agent appears promising. In diesel engines, for example, additional diesel fuel can be injected directly into the exhaust cycle of the engine by means of a conventional injection system, or an additional injection valve, through which the diesel fuel or another suitable hydrocarbon is injected, can be provided before the existing SCR catalyst. In the case of Otto-cycle internal combustion engines the exhaust gas itself generally contains a sufficient HC quantity for the NOₓ reduction.

The catalysts known from the prior art (e.g. 3-way technology for petrol and/or CNG-operated aggregates) use porous ceramic or noble metal substrates with particularly large surface areas, to which catalytically active noble metals such as platinum or rhodium are applied within a washcoat coating. However, these catalysts are complicated to produce and are, moreover, therefore frequently very costly. Moreover, it has been found that contamination of the environment occurs over time from heavy metal that has leached out of the catalyst. In addition, the motor vehicle catalysts used today are frequently extremely sensitive to sulphur and/or sulphates, which for these catalysts constitute catalyst poisons, as a result of which the catalyst is at least partially deactivated.

A further problem of the catalyst technology known from the prior art is that for an optimum effect of the catalyst a certain threshold of NOₓ must be exceeded in the exhaust gas, but this is not the case in all operating states of the engine. If the combination of all these influences is considered, then only an inadequate NOₓ reduction occurs in some circumstances.

Catalysts composed on the basis of zeolites have recently been proposed to overcome the aforementioned problems. Such catalysts are described, for example, in C. Y. Chung et al., Catalysis Today, 1999, pp. 521-529, and contain copper-added synthetic or naturally occurring zeolites, which are able to catalyse the reduction of nitrogen monoxide, NOₓ with hydrocarbons (HC) such as C₃H₆. However, it has been found that in long-term studies in real motor vehicle operation these catalysts are not stable and are subject to ageing processes, which greatly reduce their catalytic activity and therefore render them of little interest for use in a motor vehicle.

### BRIEF SUMMARY OF THE INVENTION

It is an object of the present invention to provide a simple catalyst usable in a motor vehicle that is quick and therefore inexpensive to produce, where possible avoiding the use of PGMs (platinum group metals) or metals that are volatile in the high-temperature range (such as potassium or vanadium), with which a reliable, highly effective and quick NOₓ reduction is achieved in motor vehicles.

A catalyst according to the invention is characterised in that it contains modified clay minerals selected from the group comprising bentonites, smectites, hectorites, as well as mixtures thereof, pillared with aluminium, silicon or titanium (oxides). In the sense of the present invention “contains” means in particular that the catalyst is composed to ≧30% (% by wt.), preferably to ≧60% (% by wt.) and most preferred to ≧80% (% by wt.) of the specified modified clay minerals. In the case where the catalyst contains zeolites and clay minerals, these can be contained, inter alia, in the same phase in the form of mixed crystallisate or also of mechanical mix.

In the case where the catalyst contains zeolites and clay minerals, the content of zeolites is preferably ≧10% (% by wt.), more preferred ≧20% (% by wt.), more preferred ≧30% (% by wt.), and also most preferred ≧40% (% by wt.), and also the content of clay minerals is preferably ≧10% (% by wt.), more preferred ≧20% (% by wt.), more preferred ≧30% (% by wt.), and also most preferred ≧40% (% by wt.).

For this, the hydrocarbons available in the motor vehicle (directly or firstly “reformed”) and/or CO and/or H₂ are used as actual reducing agent.

Bentonites as clay mineral catalysts for NOₓ are known in principle from the prior art, e.g. in U.S. Pat. No. 6,521,559, for use in power stations. However, firstly, the conditions in a power station differ fundamentally from those in a motor vehicle; secondly, NH₃, and not hydrocarbons, is exclusively used as reducing agent. In addition, the production of said catalyst is based on the synthesised and pillared mineral laponite, which is not obtainable on an industrial scale purely on cost grounds.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A preferred embodiment of a catalyst according to the present invention is characterized in that it contains oxidative and reductive regions, which can be formed, as desired, both on one and the same or on different minerals (clay mineral, zeolite). A particularly efficient reduction of NO can occur when firstly a portion of the NO is oxidised to NO₂ and also another portion of NO is reduced to NH₃ by means of the hydrocarbons. A recombination of several substances adsorbed on the catalyst then occurs to form N₂ and water.

Therefore, when there are regions that have an oxidative effect and those that have a reductive effect together with the hydrocarbons present within the catalyst, the efficiency of the NOₓ reduction can be substantially increased in a proven manner.

Clay minerals should be understood to mean phyllosilicates in particular, but also sheet silicates [e.g. palygorskite (attapulgite) and sepiolite (meerschaum)]. A preferred embodiment of a catalyst according to the present invention is characterised in that the clay mineral is selected from the group comprising kaolinite, ilerite, kanemite, magadiite, smectites, montmorillonite, bentonite, hectorite, palygorskite and sepiolite as well as mixtures thereof. Bentonite, sepiolite, hectorite and also montmorillonite are particularly preferred.

A preferred embodiment of a catalyst according to the present invention is characterized in that the clay mineral of the catalyst contains in particular basic-acting cations preferably selected from the group comprising Ba, Na, Sr, Ca and Mg as well as mixtures thereof. In particular it is known of Ba²⁺ ions that together with suitable clay minerals these can bind hydrocarbons and convert them into more reactive substances such as aldehydes, which then allow the NOₓ reduction.

A preferred embodiment of a catalyst according to the present invention is characterized in that the catalyst contains and/or carries oxidative-acting metal ions preferably selected from the group comprising Ag, Ce, Fe, Cu, La, Pr, Th, Nd, In, Cr, Mn, Co and Ni as well as mixtures thereof. Thus, an oxidation of NO to NO₂ can be effected according to the mechanism outlined above.

A preferred embodiment of a catalyst according to the present invention is characterized in that the catalyst is composed on the basis of modified bentonite. Further particularly preferred catalysts are characterised in that they contain modified clay minerals selected from the group comprising bentonites, smectites, hectorites, as well as mixtures thereof, pillared with aluminium, silicon or titanium (oxides).

A further embodiment of the catalyst particularly preferred in the framework of this invention contains at least one oxidative region, which contains zeolites, for example, and a reductive region, which can be formed by clay minerals. In view of the known form selectivity of the zeolites, these are particularly suitable for only oxidising the NO, while because of their size, the hydrocarbons can reach the reactive centres of the zeolites in a substantially more delayed manner and are therefore practically not oxidised. However, because of their substantially two-dimensional pore systems, clay minerals are particularly suitable for the absorption of suitable hydrocarbons.

A preferred embodiment of a catalyst according to the present invention is characterized in that the catalyst contains a zeolite selected from the group comprising naturally occurring, ion-exchanged and/or synthesised zeolite A, zeolite X, zeolite Y, heulandite, clinoptilolite, chabasite, erionite, mordenite, ferrierite, MFI (ZSM-5), zeolite-beta faujasite, mordenite or mixtures thereof.

Moreover, zeolites that are usable in the framework of the present invention can be selected from the group comprising zeolite A, zeolite X, Y and/or heulandites. Moreover, the use of clinoptilolite, chabasite, erionite, mordenite, ferrierite, MFI (ZSM-5) and also zeolite-beta is preferred. The latter zeolite structures are characterised by a lower Al content, which while it reduces the ion exchange capacity, has the advantage of high temperature stability (up to 550° C. continuous operation).

Faujasites, heulandites and mordenites are to be specified as particularly suitable zeolites. Together with zeolites X and Y, the mineral faujasite belongs to the faujasite types within zeolite structure group 4, which are characterised by the double six-membered ring subunit D6R (cf. Donald W. Breck: “Zeolite Molecular Sieves”, John Wiley & Sons, New York, London, Sydney, Toronto, 1974, page 92). The naturally occurring minerals chabazite and gmelinite as well as further synthetically obtainable zeolites also belong to zeolite structure group 4 besides the specified faujasite types.

In particular, heulandites have the general formula (Na, K)Ca₄[Al₉Si₂₇O₇₂].24H₂O or Ca₄[Al₈Si₂₈O₇₂].24H₂O). Together with the SiO₂ richer clinoptilolite, they are monoclinic in the crystal class 2/m-C2h and form foliated to tabular crystals, often grown singly or in subparallel aggregates, also shelly, scaly or sparry aggregates with perfect cleavage with pearl-like lustre on the cleavage faces (see also Gottardi-Galli, Natural Zeolites, pp. 256-284).

Mordenites have the general structure Na₃KCa₂[Al₈Si₄₀O₉₆].28H₂O. Structural units of the crystalline structure are five-membered rings of tetrahedrons, which form superposed chains. Through the joint corners of two tetrahedrons of five-membered rings, four-membered rings are also formed; four- or five-membered rings jointly enclose twelve-membered rings: see illustration. Mordenite forms tiny prismatic, needle-like or fine-fibred white to colourless crystals, often in the form of cotton-like aggregates, and sturdy vitreous masses (see also Gottardi-Galli, Natural Zeolites, pp. 223-233, Berlin-Heidelberg: Springer 1985).

Zeolites of the faujasite type are structured from β-cages, which are linked tetrahedrally via D6R subunits, wherein the β-cages are arranged in a similar manner to the carbon atoms in diamond. The three-dimensional network of the zeolites of the faujasite type suitable according to the invention has pores of 2.2 and 7.4 Å, and moreover the unit cell contains 8 cavities (super-cages) with a diameter of approximately 13 Å and can be represented by the formula Na₈₆[(AlO₂)₈₆(SiO₂)₁₀₆].n H₂O (n is preferably 264). (All data from: Donald W. Breck: “Zeolite Molecular Sieves”, John Wiley & Sons, New York, London, Sydney, Toronto, 1974, pages 145, 176, 177).

Mixes, mixed crystals and/or co-crystallisates of zeolites of the faujasite type (also in the form of mechanical mixes) are also suitable according to the invention besides other zeolite structures, which do not necessarily have to belong to zeolite structure 4 (according to the Breck classification), wherein preferably at least 70% by wt. of zeolites of the faujasite type, mordenites and/or heulandites are contained.

The zeolites used in the framework of this invention preferably have pore sizes of 2.8-8.0 Å. In general, it applies that in some instances the said pore radius varies considerably with the Al content of the zeolites and the type and quantity of the co-cations for the charge equalisation (alkali metals, alkaline earth metals, subgroup elements).

A preferred embodiment of a catalyst according to the present invention is characterized in that the percentage content by weight of copper and/or iron in the catalyst, measured on the basis of the weight of the entire catalyst, lies between ≧0% by wt. and ≦25% by wt., preferably between ≧0.01% by wt. and ≦20% by wt., more preferred between ≧0.05% by wt. and ≦15% by wt., and also most preferred between ≧0.1% by wt. and ≦10% by wt. Because of their catalytic activity, iron and copper have a further efficiency-enhancing effect. Further suitable metals are, inter alia, silver, cerium, manganese, indium and/or platinum, wherein the latter is less preferred.

With the exception of copper, iron and also possibly titanium, the catalyst is heavy metal-free, wherein heavy metal-free in the sense of the present invention means that the catalyst contains less than ≦1% by wt., preferably less than ≦0.8% by wt., more preferred less than ≦0.6% by wt., more preferred less than ≦0.4% by wt., and also most preferred less than ≦0.1% by wt. of heavy metals. In the sense of the present invention, heavy metals are understood in particular to be the platinum group elements.

A preferred embodiment of a catalyst according to the present invention is characterised in that the catalyst additionally also carries metal oxides, wherein the metal of the metal oxide is not a heavy metal with the exception of possibly copper, iron, indium, molybdenum or titanium.

It is particularly preferred that the catalyst also contains aluminium oxide. As a result of the pillar process, this has a substantial surface-increasing effect, wherein the interlayer spacing of the minerals can be permanently widened through nano-oxides formed, which in turn allows the generation of a permanent pore system within the catalyst. Reference is made to N. D. Hudson et al., Microporous and Mesoporous Materials, 1999, pp. 447-459 in this regard. A further preferred oxide is titanium oxide or silicon oxide, which can likewise be used to increase the surface and construct the “pillared clays”.

A preferred embodiment of a catalyst according to the present invention is characterized in that the content of metal oxide in mmol per g of catalyst amounts to ≦100 mmol of metal/g, more preferred ≦50 mmol of metal/g, further ≦20 mmol of metal/g, ≦10 mmol of metal/g, and also most preferred from ≦6 mmol of metal/g to ≧0 mmol of metal/g, preferably ≧1 mmol of metal/g.

In a preferred embodiment of the catalyst, copper can be used as an additional catalytically active component. Copper presumably takes on the decisive role of an active centre in the complex catalytic process of NOₓ reduction. This role can evidently also be assumed by iron, manganese, indium, molybdenum and to a certain degree also titanium, which are therefore likewise preferred in the framework of the present invention. It is assumed that as promoters these co-cations further improve the efficiency of the copper.

As mentioned above, copper-laden zeolites (such as Cu/ZSM-5) are already known principally as active catalyst in the de-NOₓ process, however sufficiently stable forms for real exhaust gas conditions (up to 800° C., to 20% by vol. of water, sulphur compounds) have not as yet been successfully produced. The decisive co-cation stabilising function is possibly attributed to the clay minerals. Particularly suitable for this are modified clay minerals (ion-exchanged pillared clays: so-called PILCs) or naturally occurring zeolites such as clinoptilolite and/or mordenite.

The percentage content by weight of (elemental) copper in the catalyst, measured on the basis of the weight of the entire catalyst, preferably lies between ≧0.01% and ≦25%, preferably between ≧0.1% and ≦20%, more preferred between ≧1% and ≦15%, and also most preferred between ≧2% and ≦10%. These data also apply to the active metal or iron acting as co-cation, wherein mixtures of both metals have also been positively tested. Improvements in activity could be achieved through Ti and/or Ag, Ce additions and/or La additions and/or Ca, Co, Ni, In, Cr and Mn as trace quantity additions, which therefore likewise constitute preferred additions. In the case of clay minerals, ion-exchanged samples pillared with Al, Si and/or with Ti and/or Cu, Fe are particularly effective and preferred on this basis.

A preferred embodiment of a catalyst according to the present invention is characterized in that the microporous average pore size lies between ≧0 nm and ≦2 nm, preferably between ≧0.1 nm and ≦1.0 nm, more preferred between ≧0.2 nm and ≦0.8 nm, and also most preferred between ≧0.21 nm and ≦0.6 nm.

A preferred embodiment of a catalyst according to the present invention is characterized in that the mesoporous average pore size lies between ≧0 nm and ≦10 nm, preferably between ≧1 nm and ≦9 nm, more preferred between ≧2 nm and ≦8 nm, and also most preferred between ≧2.5 nm and ≦7 nm.

A preferred embodiment of a catalyst according to the present invention is characterized in that the surface (measured according to the BET method or in the multipoint process) of the clay mineral and/or zeolite, which forms the basis of the catalyst, in the catalyst product lies between ≧0 m²/g and ≦1000 m²/g, preferably between ≧20 m²/g and ≦800 m²/g, more preferred between ≧50 m²/g and ≦600 m²/g, and also most preferred between ≧90 m²/g and ≦450 m²/g.

A preferred embodiment of a catalyst according to the present invention is characterized in that the micropore volume of the clay mineral and/or zeolite, which forms the basis of the catalyst, in the catalyst product lies between ≧0 cm³/g and ≦0.4 cm³/g, preferably between ≧0.02 cm³/g and ≦0.25 cm³/g, more preferred between ≧0.04 cm³/g and ≦0.2 cm³/g, and also most preferred between ≧0.05 cm³/g and ≦0.18 cm³/g.

A preferred embodiment of a catalyst according to the present invention is characterized in that the mesopore volume of the clay mineral and/or zeolite, which forms the basis of the catalyst, in the catalyst product lies between ≧0 cm³/g and ≦1.0 cm³/g, preferably between ≧0.01 cm³/g and ≦0.80 cm³/g, more preferred between ≧0.015 cm³/g and ≦0.60 cm³/g, and also most preferred between ≧0.020 cm³/g and ≦0.51 cm³/g.

A preferred embodiment of a catalyst according to the present invention is characterized in that the interlayer spacing between two layers of the clay mineral and/or zeolite-type mineral, which forms the basis of the catalyst, in the catalyst product lies between ≧0 nm and ≦5 nm, preferably between ≧0.5 nm and ≦3 nm, more preferred between ≧1.0 nm and ≦2.5 nm, and also most preferred between ≧1.4 nm and ≦2.1 nm.

A preferred embodiment of a catalyst according to the present invention is characterized in that the catalyst has a thermal loading in steady state of ≧300° C., preferably of ≧400° C., more preferred of ≧500° C., further preferred of ≧600° C., and also most preferred of ≧650° C. and ≦700° C.

The binder required for the monolith formation can likewise be produced on the basis of materials already described, wherein doping with the active element is omitted here. Therefore, full extrudates comprising a clay mineral/zeolite composite as catalyst and/or adsorbent are also possible. If the use of metal foils as substrate is desired, the active material can also be applied using a washcoat (coating) technology. The range of modification possibilities and/or production processes is not exhausted with this; plasma-assisted processes for coating or CVD (chemical vapour deposition), impregnation, wet precipitation and further methods frequently used for catalyst preparation can also be successfully applied.

On the one hand, it is possible to directly use naturally occurring minerals (zeolites and clay minerals) according to the invention, and on the other hand synthetically produced aluminosilicates with specified structure can be used for this purpose. Their production can generally be most inexpensive as a result of low synthesis temperatures (≦100° C., no autoclave technique), short synthesis times and also through the saving or dispensing with expensive, organic template molecules (mostly alkyl ammonium salts such as TPABr/TPAOH) for the production. The advantages of natural minerals are fully realised in particular in the case of clay minerals, since a synthesis and/or purification process in preparation for the delamination, pillaring/ion exchange is very time-consuming and costly.

A method as described above and a catalyst as described above according to the present invention can be used in all motor vehicles and motor vehicle types. In this case, it is of no consequence whether these are automobiles or lorries, for example, or whether Otto-cycle, diesel or CNG engines are used. Engines equipped with the most modern combustion processes such as HCCI (homogeneous charge compression ignition) or CAI (controlled auto ignition) can also benefit from this method.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A catalyst for purifying NOₓ in the flow of exhaust gas of motor vehicles, wherein the catalyst comprises:
a modified clay mineral selected from the group comprising bentonites, smectites, hectorites, or mixtures thereof, pillared with aluminium, silicon or titanium (oxides); and
a zeolite comprising zeolite A, zeolite X, zeolite Y, heulandite, clinoptilolite, chabasite, erionite, mordenite, ferrierite, MFI (ZSM-5), zeolite-beta faujasite, mordenite or mixtures thereof, wherein zeolite is naturally occurring, ion-exchanged, synthesized or a combination thereof.

2. The catalyst according to claim 1, wherein the catalyst comprises oxidative and reductive regions.

3. The catalyst according to claim 1, wherein the clay mineral of the catalyst comprises basic-acting cations selected from the group consisting of Ba, Na, Sr, Ca and Mg as well as mixtures thereof.

4. The catalyst according to claim 1, wherein the catalyst comprises oxidative-acting metal ions selected from the group consisting of Ag, Ce, Fe, Cu, La, Pr, Th, In, Nd, Cr, Mn, Co and Ni as well as mixtures thereof.

5. The catalyst according to claim 1, wherein the percentage content by weight of copper and/or iron in the catalyst, measured on the basis of the weight of the entire catalyst, is between ≧0% by wt. and ≦25% by wt.

6. The catalyst according to claim 1, wherein the catalyst additionally comprises a metal oxide, wherein the metal of the metal oxide is not a heavy metal with the exception of copper, iron or titanium.

7. The catalyst according to claim 6, wherein the catalyst additionally comprises aluminium oxide.

8. The catalyst according to claim 6, wherein the content of metal oxide in mmol per g of catalyst is ≦100 mmol of metal/g.

9. The catalyst according to claim 1, wherein the microporous average pore size is between ≧0 nm and ≦2 nm.

10. The catalyst according to claim 1, wherein the mesoporous average pore size is between ≧0 nm and ≦10 nm.

11. The catalyst according to claim 1, wherein the surface of the clay mineral, zeolite, or both is between ≧0 m²/g and ≦1000 m²/g.

12. The catalyst according to claim 1, wherein the micropore volume of the clay mineral, the zeolite, or both is between ≧0 cm³/g and ≦0.4 cm³/g.

13. The catalyst according to claim 1, wherein the mesopore volume of the clay mineral, the zeolite, or both is between ≧0 cm³/g and ≦1.0 cm³/g.

14. The catalyst according to claim 1, wherein the interlayer spacing between two layers of the clay mineral, the zeolite-type mineral, or both is between ≧0 nm and ≦5 nm.

15. The catalyst according to claim 1, wherein the catalyst has a thermal loading in steady state of ≧300° C.

16. A motor vehicle including a catalyst according to claim 1.
